(19) United States
(12) Patent Application Publication
(10) Pub. No.: US 2026/0010012 A1
(43) Pub. Date: Jan. 8, 2026

(54) ADJUSTMENT ASSEMBLY

(71) Applicant: Apple Inc., Cupertino, CA (US)

(72) Inventor: Trevor S. Chambers, San Diego, CA (US)

(21) Appl. No.: 19/042,775

(22) Filed: Jan. 31, 2025

Related U.S. Application Data
(60) Provisional application No. 63/667,587, filed on Jul. 3, 2024.

(51) Int. Cl. G02B 27/01

(52) U.S. Cl. CPC G02B 27/0176; G02B 2027/0154

(57) ABSTRACT

A head-mountable device can include a display frame, an optical component coupled to the display frame, a facial track, and an adjustment assembly. In some examples, the adjustment assembly can include a first extension arm coupling the display frame and the facial track. In at least one example, adjustment assembly can include a second extension arm coupling the display frame and the facial track. In some examples, a first end of the first extension arm and a first end of the second extension arm can be connected to a rotational hinge. In some examples, a second end of the first extension arm can be connected to a first sliding joint and a second end of the second extension arm can be connected to a second sliding joint. In some examples, the adjustment assembly can be configured to cause a linear adjustment of the display frame relative to the facial track.

### CROSS-REFERENCE TO RELATED APPLICATION(S)

This application claims priority to U.S. Provisional Patent Application No. 63/667,587, filed 3 Jul. 2024, and entitled “ADJUSTMENT ASSEMBLY,” the entire disclosure of which is hereby incorporated by reference.

### FIELD

The described embodiments relate generally to a head-mountable device. More particularly, the present embodiments relate to adjustment mechanisms for head-mountable devices.

### BACKGROUND

Recent advances in portable computing have enabled head-mountable devices (HMDs) that provide augmented and virtual reality (AR/VR) experience to users. HMDs have many components, such as a display, a viewing frame, a lens, batteries, and other components. HMDs typically include a set of optical components that enable a user to view and interact with visualizations presented through the HMD. In many HMDs, the position and/or angle of the optical components relative to the user can be difficult to adjust or otherwise manipulate. Some positions of optical components relative to the user of an HMD can be uncomfortable to users with varying facial structures, operation preferences, or eyesight conditions. Users may desire the optical components to be positioned at a depth that enables the user to comfortably focus on the optical components when interacting with an external environment.

Adjustment mechanisms in conventional HMDs can also reduce the rigidity and overall structural integrity of the device. These adjustment mechanisms may not be configured to withstand forces the HMD experiences during operation. Additionally, conventional adjustment mechanisms in HMDs may be uncomfortable for users, depending on individual head size and shape.

Therefore, a need exists in the art for adjustment mechanisms of a head-mountable device capable of easily adjusting the position of optical components relative to a user while maintaining or increasing the structural integrity of the device.

### SUMMARY

In accordance with one or more examples of the present disclosure, a head-mountable device can include a display frame. In some examples, the head-mountable device can also include an optical component coupled to the display frame. In some examples, the head-mountable device can also include a facial track.

In at least one example, the head-mountable device can also include an adjustment assembly. In some examples, the adjustment assembly can include a first extension arm coupling the display frame and the facial track. In some examples, the adjustment assembly can include a second extension arm coupling the display frame and the facial track. In one or more examples, a first end of the first extension arm and a first end of the second extension arm can be connected to a rotational hinge.

In some examples, a second end of the first extension arm can be connected to a first sliding joint. In at least one example, a second end of the second extension arm can be connected to a second sliding joint. In some examples, the adjustment assembly can be configured to cause a linear adjustment of the display frame relative to the facial track. In some examples, the head-mountable device can include a first set of extension arms including the first extension arm and the second extension arm. In at least one example, the head-mountable device can further include a second set of extension arms opposite the first set, including third and fourth extension arms. In some examples, the rotational hinge is a first rotational hinge, and the head-mountable device can include a second rotational hinge.

In some examples, the head-mountable device can include where the linear adjustment of the facial track and the display frame corresponds to at least one of a change in depth of field or field of view as perceived by a user of the head-mountable device. In at least one example, the head-mountable device can also include where the rotational hinge can be configured to lock in different positions corresponding to the linear adjustment of the facial track and the display frame.

In one or more examples of the present disclosure, the linear adjustment of the head-mountable device can be guided by the first set of extension arms and the second set of extension arms. In some examples, the first extension arm and the second extension arm can be curved. In some examples, the head-mountable device can include a light-blocking shroud that can enclose the first extension arm and the second extension arm. Additionally, the light-blocking shroud can be disposed between the facial track and the display frame.

In some examples of the present disclosure, a wearable apparatus can include a head-mountable display. In at least one example, the wearable apparatus can include a facial contact. The wearable apparatus can also include a first support link adjustably securing the head-mountable display to the facial contact. Additionally, the wearable apparatus can include a second support link adjustably securing the head-mountable display to the facial contact.

In some examples, the first support link and the second support link can define a gap between the facial contact and the head-mountable display. In at least one example, a first end of the first support link and a first end of the second support link can be connected to a rotational hinge. In some examples, an actuation of the rotational hinge can be configured to change a size of the gap between the facial contact and the head-mountable display. In one or more examples, the rotational hinge can be configured to lock the first support link in a position defining a size of the gap.

In one or more examples, the rotational hinge can be configured to be manually actuated. In some examples, the rotational hinge can be configured to be actuated by a motor. In at least one example, the rotational hinge includes a spring-detent locking mechanism configured to lock the first support link in any one of a set of discrete positions including the aforementioned position. In some examples, the rotational hinge can include a friction clutch. In at least one example, the friction clutch can be configured to be fixed in position when not acted upon by an external force. In some examples, the rotational hinge can be removably secured to the wearable apparatus.

In some examples, an expandable link can be disposed between the head-mountable display and the facial contact. In at least one example, the expandable link can be configured to change the size of the gap between the facial contact and the head-mountable display. In one or more examples of the present disclosure, the wearable apparatus can include a sliding lock configured to lock the rotational hinge in place. In some examples, the sliding lock can include a locking arm connected between the wearable apparatus and at least one of the first support link or the second support link.

In at least one example, a display adjustment assembly can include a display frame. In some examples, the display adjustment assembly can further include an optical component coupled to the display frame, a facial track, a first extension arm disposed between the display frame and the facial track, and a second extension arm disposed between the display frame and the facial track. In some examples, the first support arm and the second extension arm can be configured to create a gap between the facial track and the display frame. In some examples, a first end of the first extension arm and a first end of the second extension arm can both be rotationally secured to the display frame or the facial track. In at least one example, a first sliding joint can be configured to receive a second end of the first extension arm, and a second sliding joint can be configured to receive a second end of the second extension arm.

In some examples, the first sliding joint can include a channel extending in a first direction. In at least one example, the second end of the first extension arm can be configured to travel across a length of the channel. In some examples, the second sliding joint can include a channel extending in a second direction different than the first direction. In at least one example, the second end of the second extension arm can be configured to travel across a length of the channel. In one or more examples of the present disclosure, a first movement of the first extension arm in the first sliding joint and a second movement of the second extension arm in the second sliding joint can cause guided linear motion between the facial track and the display frame. Other technical features may be readily apparent to one skilled in the art from the following figures, descriptions, and claims.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates a perspective view of a head-mountable device, according to one or more examples of the present disclosure;

FIG. 2A illustrates a side view of the head-mountable device, according to one or more examples of the present disclosure;

FIG. 2B illustrates a side view of the head-mountable device in an extended position, according to one or more examples of the present disclosure;

FIG. 2C illustrates another side view of the head-mountable device in a shortened position, according to one or more examples of the present disclosure;

FIG. 2D illustrates a top-down view of the head-mountable device, according to one or more examples of the present disclosure;

FIG. 3 illustrates a front view of a facial contact with sliding joints, according to one more examples of the present disclosure;

FIG. 4 illustrates a perspective view of the head-mountable device with a light-blocking shroud, according to one or more examples of the present disclosure;

FIG. 5 illustrates an example of a rotational hinge, according to one or more examples of the present disclosure;

FIG. 6A illustrates a first position of the head-mountable device with a sliding lock and locking arm, according to one or more examples of the present disclosure;

FIG. 6B illustrates a second position of the head-mountable device with a sliding lock and locking arm, according to one or more examples of the present disclosure;

FIG. 7A illustrates a first position of the head-mountable device with an expandable link, according to one or more examples of the present disclosure;

FIG. 7B illustrates a second position of the head-mountable device with an expandable link, according to one or more examples of the present disclosure;

FIG. 8 illustrates a side view of the head-mountable device in a canted position, according to one or more examples of the present disclosure; and

FIG. 9 illustrates a blown-up perspective view of the rotational hinge, according to one or more examples of the present disclosure;

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates generally to adjustment mechanisms of a head-mountable device. More particularly, the present disclosure relates to adjustment mechanisms for head-mountable devices. HMDs can provide augmented and virtual reality (AR/VR) experience to various users. Certain components of an HMD can also help create a unique user experience, such as a set of optical components projecting visual content to the user. In some examples, the optical components can enable a user to view and interact with visualizations presented through the HMD. The position and/or angle of the optical components relative to the user in current HMDs can be difficult to adjust or otherwise manipulate. Some positions of optical components relative to the user of an HMD can be uncomfortable to users with varying facial structures, operation preferences, or eyesight conditions. For example, users with varying levels of eyesight can desire the optical components positioned at different distances and/or angles. Additionally, adjustment mechanisms in conventional HMDs may not be configured to withstand a number of forces a user may exert on the HMD during operation. The present disclosure relates to an adjustment mechanism of a head-mountable device capable of easily adjusting the position of optical components relative to a user while maintaining or increasing the structural integrity of the device.

Accordingly, in some examples, the head-mountable devices disclosed herein can include an adjustment assembly. In some examples, this adjustment assembly can include a first extension arm and a second extension arm coupling the display frame and the facial engagement structure or face track. In some examples, a first end of the first extension arm and a first end of the second extension arm can be connected to a rotational hinge. In one or more examples, a second end of the first extension arm can be connected to a first sliding joint. Similarly, a second end of the second extension arm can be connected to a second sliding joint. In some examples, the first and second extension arms can be connected to head-mountable device in multiple locations, thus increasing the structural support between the display frame and the facial track.

In some examples, the adjustment assembly can be configured to cause a linear adjustment of the display frame relative to the facial track. In some examples, the linear adjustment can enable the optical components of the HMD to remain on the same axis as the facial track. This linear adjustment enables the optical components to stay within view of the user during operation of the HMD.

In some examples, the rotational hinge can be secured to either the display frame or the facial track. In some examples, the sliding joints can be disposed on a component not secured to the rotational hinge. For example, if the rotational hinge is secured to the display frame, the sliding joints can be disposed on the facial track. In some examples, the first and second extension arms can extend from the rotational hinge to the sliding joints, thus maintaining or increasing the structural integrity between the display frame and the facial track.

In some examples, the first and second extension arms of the head-mountable device can be a first set of extension arms. In at least one example, the head-mountable device can include a second set of extension arms extending from a second rotational hinge to additional sliding joints. In some examples, the first and second sets of extension arms can couple different sides of the display frame and the facial track together. For example, the first set of extension arms can couple the left side of the display frame to the left side of the facial track and the second set of extension arms can couple the right sides of the display frame and the facial track. These extension arms can increase the structural support between the display frame and the facial track.

In some examples, the rotational hinge can be manually actuated by the user of the head-mountable device or actuated by a motor. In some examples, actuation of the rotational hinge can move the position of the first and second extension arms, where the first and second extension arms can define a gap between the display frame and the facial track. In some examples, the rotational hinge can include a spring-detent locking mechanism configured to lock the first extension arm in any one of a set of discrete positions. In additional examples, the rotational hinge can include a friction clutch configured to be fixed in position when not acted upon by an external force. Such a rotational hinge can enable a user to easily change the position of the optical components of the head-mountable device.

In some examples, the display frame can be configured to change angles relative to the facial track. In at least one example, the first extension arm can move a different distance than the second extension arm, or vice versa. In this example, the angle of the display frame relative to the facial track can be adjusted such that the user can easily adjust the angle of the optical components of the head-mountable device.

In one or more examples, the second ends of the first and second extension arms can be configured to move across the length of the sliding joints when the distance between the display frame and the facial track is changed. In some examples, this can enable the display frame to remain in line with the facial track for different distances between components. Such an alignment during adjustment enables the optical components to remain in view of the user for different distances between the facial track and the display frame.

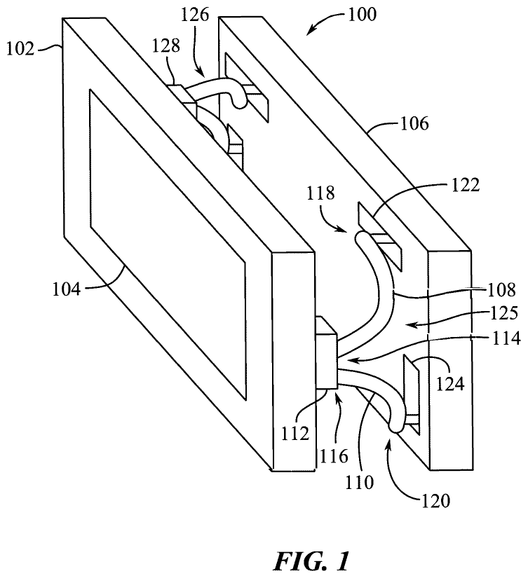

These and other embodiments are discussed below with reference to FIGS. 1-9. However, those skilled in the art will readily appreciate that the detailed description given herein with respect to these Figures is for explanatory purposes only and should not be construed as limiting.

FIG. 1 illustrates a perspective view of a head-mountable device 100, in accordance with one or more examples of the present disclosure. In some examples, the head-mountable device 100 can be a wearable apparatus that can be donned by a user. In some examples, the head-mountable device 100 can include a display frame 102. In at least one example, the display frame 102 can be a head-mountable display configured to be coupled to various components of the head-mountable device 100. In some examples, the display frame 102 can be configured to rest on the head of a user such that the display frame 102 can be positioned in front of the eyes of the user.

In at least one example, the display frame 102 can be coupled to an optical component 104. In some examples, the optical component 104 can be configured for the user of the head-mountable device 100 to look through. In some examples, the head-mountable device 100 can be configured to display various information to the user. For example, the optical component can be a screen, a window, or other component that can enable the user to view their surroundings or data projected by the head-mountable device 100. In at least one example, the head-mountable device 100 can also be a display adjustment assembly that can adjust the optical component 104 in relation to the user, thus making a more comfortable experience for the user when operating the head-mountable device 100.

In some examples, the head-mountable device 100 can further include a facial track 106. In some examples, the facial track 106 can be a facial engagement structure or facial contact configured to make contact with the face of the user when donning the head-mountable device 100. In some examples, the facial track 106 can be constructed out of a rigid material. In other examples, the facial track 106 can be constructed out of a flexible material, or a mix of both rigid and flexible materials. This can enable a comfortable experience for the user when donning and/or operating the head-mountable device 100. In some examples, the facial track 106 can conform to the shape of the head of the user.

In some examples, the user of the head-mountable device 100 can view the optical component 104 through the facial track 106. In this example, the facial track 106 can include a viewing window, be constructed out of a transparent material, or be constructed in a way such that the facial track 106 does not obstruct the view of the user of the head-mountable device 100. For example, the facial track 106 can be constructed to be positioned generally peripherally around the eyes of a user. In this example, the facial track 106 can be configured to contact the face of the user across the forehead, around the temples, under the eyes, and across the bridge of the nose, leaving the eyes of the user unobstructed.

In some examples, the head-mountable device 100 can include an adjustment assembly. In some examples, the adjustment assembly can be a combination of components that can adjust the optical component 104 in relation to the eyes of the user. In at least one example, the adjustment assembly can include a first extension arm 108. In one or more examples, the first extension arm 108 can be a rigid support link coupling the display frame 102 and the facial track 106. In some examples, the adjustment assembly can also include a second extension arm 110. Similar to the first extension arm 108, the second extension arm 110 can be a rigid support link coupling the display frame 102 to the facial track 106. In some examples, the first extension arm 108 and the second extension arm 110 can be constructed out of plastics, metals, carbon fiber, or other rigid materials.

In one or more examples of the present disclosure, a first end 114 of the first extension arm 108 and a first end 116 of the second extension arm 110 can be connected to a rotational hinge 112. In at least one example, the rotational hinge 112 can be coupled to the display frame 102. In other examples, the rotational hinge 112 can be coupled to the facial track 106. In this manner, the rotational hinge 112 can be configured to couple to either the display frame 102 or the facial track 106. In some examples, the rotational hinge 112 can enable the first extension arm 108 and the second extension arm 110 to rotate and change positions. This movement can enable the facial track 106 to move in relation to the display frame 102. In some examples, the first end 114 of the first extension arm 108 and the first end 116 of the second extension arm 110 are both rotationally secured to the display frame 102 or the facial track 106. Additional functionality and utility of the rotational hinge 112 will be discussed throughout the present disclosure.

In some examples, a second end 118 of the first extension arm 108 can be connected to a first sliding joint 122. Similarly, a second end 120 of the second extension arm 110 can be connected to a second sliding joint 124. In at least one example, the first sliding joint 122 and the second sliding joint 124 can be disposed on the display frame 102. In other examples, the first sliding joint 122 and the second sliding joint 124 can be disposed on the facial track 106. In some examples, the first sliding joint 122 and the second sliding joint 124 can be disposed on either the display frame 102 or the facial track 106, where the rotational hinge 112 is disposed opposite the first and second sliding joints 122 and 124, respectively. For example, if the rotational hinge 112 is coupled to the display frame 102, the first and second sliding joints 122 and 124 can be disposed on the facial track 106.

In some examples, the first and second extension arms 108 and 110 can be a first set of extension arms 125. In at least one example, the head-mountable device 100 can include a second set of extension arms 126. In some examples, the second set of extension arms 126 can be disposed opposite the first set of extension arms 125. For example, as shown in FIG. 1, if the first set of extension arms 125 is disposed on the right side of the head-mountable device 100, the second set of extension arms 126 can be disposed on the left side of the head-mountable device 100. This additional set of extension arms can increase the rigidity of the head-mountable device 100.

In at least some examples, and as shown in FIG. 1, the head-mountable device 100 can further include a second rotational hinge 128. In some examples, the extension arms of the second set of extension arms 126 can be connected to the second rotational hinge 128. Additionally, the second set of extension arms 126 can be connected to respective sliding joints similar to as described for the first set of extension arms 125. This can enable the second set of extension arms 126 to operate similar to the first set of extension arms 125. This can further increase the ability of the head-mountable device 100 to support the optical component 104 in a position desired by the user.

In some examples, the first extension arm 108 and the second extension arm 110 are curved, as shown in FIG. 1. In some examples, the curve of the first extension arm 108 and the second extension arm 110 can enable a linear adjustment between the display frame 102 and the facial track 106. The curved shape of the extension arms can help reduce off-axis moments during the linear adjustment of the head-mountable device 100. More examples of the linear adjustment function are described throughout the present disclosure.

Any of the features, components, and/or parts, of the arrangements and configurations thereof shown in FIG. 1 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 1.

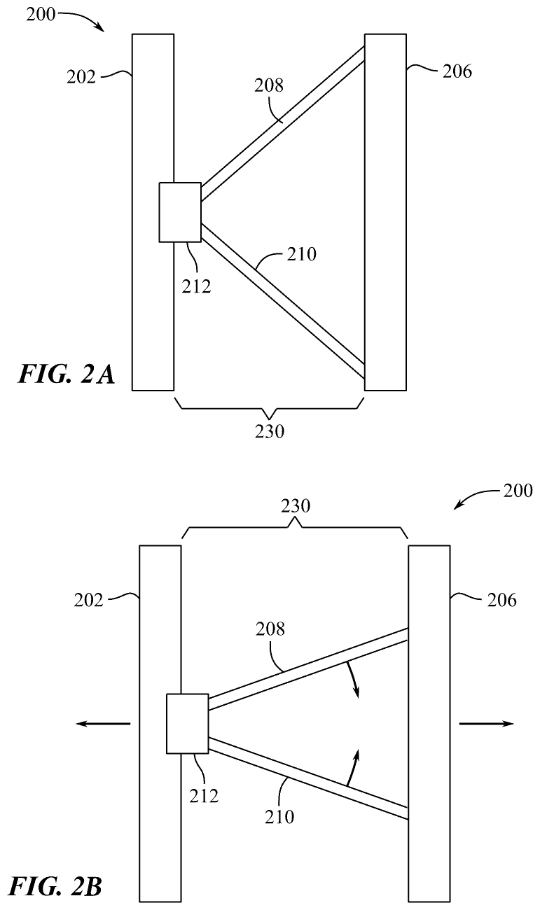

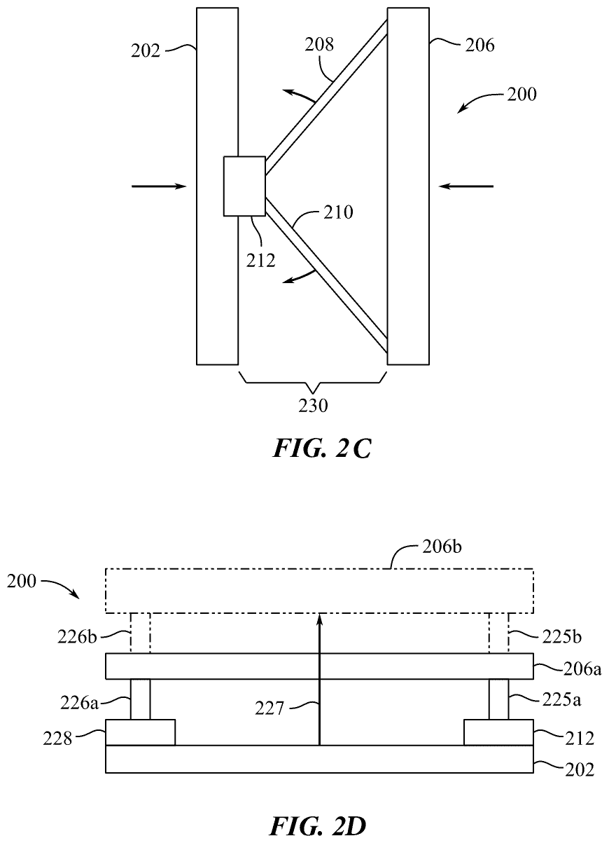

FIG. 2A illustrates a side view of the head-mountable device 200, in accordance with one or more examples of the present disclosure. In some examples, the first extension arm 208 and the second extension arm 210 can be configured to create a gap 230 between the facial track 206 and the display frame 202. In some examples, the first extension arm 208 and the second extension arm 210 can define the gap 230 between the facial track 206 and the display frame 202.

FIG. 2A shows the head-mountable device 200 in a fixed position. In some examples, the rotational hinge 212 can be configured to lock in different positions corresponding to the linear adjustment of the facial track 206 and the display frame 202. FIGS. 2B and 2C show variations of the linear adjustment between the facial track 206 and the display frame 202. In these examples, rotation of the first and second extension arms 208 and 210 change such that the gap 230 changes size, thus increasing or decreasing the distance between the facial track 206 and the display frame 202.

FIG. 2B illustrates a side view of another position of the head-mountable device 200, in accordance with one or more examples of the present disclosure. In some examples, an actuation of the rotational hinge 212 can be configured to change the size of the gap 230 between the facial track 206 and the display frame 202. In this example, the actuation of the rotational hinge 212 can increase the size of the gap 230, thus increasing the distance between the display frame 202 and the facial track 206.

In some examples, the rotational hinge 212 can further be configured to lock the first extension arm 208 in a position defining the size of the gap 230. As shown in FIG. 2B, the first extension arm 208 can be locked in this position, thereby retaining a larger separation between the display frame 202 and the facial track 206. In some examples, the second extension arm 210 can also be locked in place. This can enable the user of the head-mountable device 200 to change the distance between the facial track 206 and the display frame 202 without the gap 230 reverting to a previous size or moving unintentionally during operation.

In some examples, the position the first extension arm 208 and the second extension arm 210 can move when size of the gap 230 is changed. As shown by the arrows 211 in FIG. 2B, the first and second extensions arms 208 and 210 can move closer together when the size of the gap 230 is increased. Additionally, both of the extension arms 208 and 210 can lock into place to retain these new positions, thus fixing the position of the display frame 202 relative to the facial track 206. This can enable the user to comfortably operate the head-mountable device 200.

In one or more examples, the rotational hinge 212 can be configured to be manually actuated. For example, the user can pull the display frame 202 from the facial track 206 to actuate the rotational hinge 212. In other examples, the rotational hinge 212 can be configured to be actuated by a motor. In this example, the user of the head-mountable device 200 can change the size of the gap 230 via the motor. This can enable users of varying ability to more easily change adjust the head-mountable device 200 as desired.

FIG. 2C illustrates a side view of another position of the head-mountable device 200, in accordance with one or more examples of the present disclosure. In this example, the actuation of the rotational hinge 212 can increase the size of the gap 230, thus increasing the distance between the display frame 202 and the facial track 206.

In some examples, the rotational hinge 212 can further be configured to lock the first extension arm 208 in a position defining the size of the gap 230. As shown in FIG. 2C, the first extension arm 208 can be locked in this position, retaining a smaller separation between the display frame 202 and the facial track 206. In some examples, the second extension arm 210 can also be locked in place. This can enable the user of the head-mountable device 200 to change the distance between the facial track 206 and the display frame 202 without the gap 230 reverting to a previous size or moving unintentionally during operation.

In some examples, the position the first extension arm 208 and the second extension arm 210 can move when size of the gap 230 is changed. As shown by the arrows 213 in FIG. 2C, the first and second extensions arms 208 and 210 can move farther apart when the size of the gap 230 is decreased. Additionally, both of the extension arms 208 and 210 can lock into place to retain these new positions, thus fixing the position of the display frame 202 relative to the facial track 206. This can enable the user to more comfortably operate the head-mountable device 200.

FIG. 2D illustrates a top-down view of the head-mountable device 200, in accordance with one or more examples of the present disclosure. In some examples, the adjustment assembly of the head-mountable device 200 can be configured to cause a linear adjustment of the display frame 202 relative to the facial track 206a. In some examples, the linear adjustment of the head-mountable device 200 can be guided by the first set of extension arms 225 and the second set of extension arms 226. This can enable the display frame 202 to move in a linear fashion relative to the facial track 206a. In one example, linear motion between the display frame 202 and the facial track 206 can include relative motion where both the frame 202 and facial track 206 maintain the same central, normal axis of motion and/or where the peripheral edges or geometries of the frame 202 and facial track 206 are generally aligned between an initial and final relative position as well as being generally aligned throughout the motion between the two positions.

An example of this linear adjustment is shown in FIG. 2D. In this example, the first and second rotational hinges 212 and 228 are disposed on the display frame 202. Furthermore, the head-mountable device 200 is shown to increase the separation between the facial track 206a and the display frame 202. A first position of the facial track 206a is shown with solid lines, and a second position of the facial track 206b is shown with dotted lines. As the separation between the facial track 206a and the display frame 202 changes, the first set of extension arms 225a and the second set of extension arms 226a can move to positions. In this example, a second position for the first set of extension arms 225b and a second position for the second set of extension arms 226b can be correlated with the second position of the facial track 206b.

The second position of the facial track 206b can be linearly aligned with the display frame 202, as shown in FIG. 2D by a linear axis 227. In some examples, the first set of extension arms 225a and the second set of extension arms 226a can guide the head-mountable device 200 to move along the linear axis 227. In at least one example, the first and second sets of extension arms 225a and 226a can help reduce off-axis moments between the facial track 206a and the display frame 202.

The head-mountable device of claim 1, wherein the linear adjustment of the facial track and the display frame correspond to at least one of a change in depth of field or field of view as perceived by a user of the head-mountable device.

Any of the features, components, and/or parts, of the arrangements and configurations thereof shown in FIGS. 2A-2D can be included, cither alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 2A-2D.

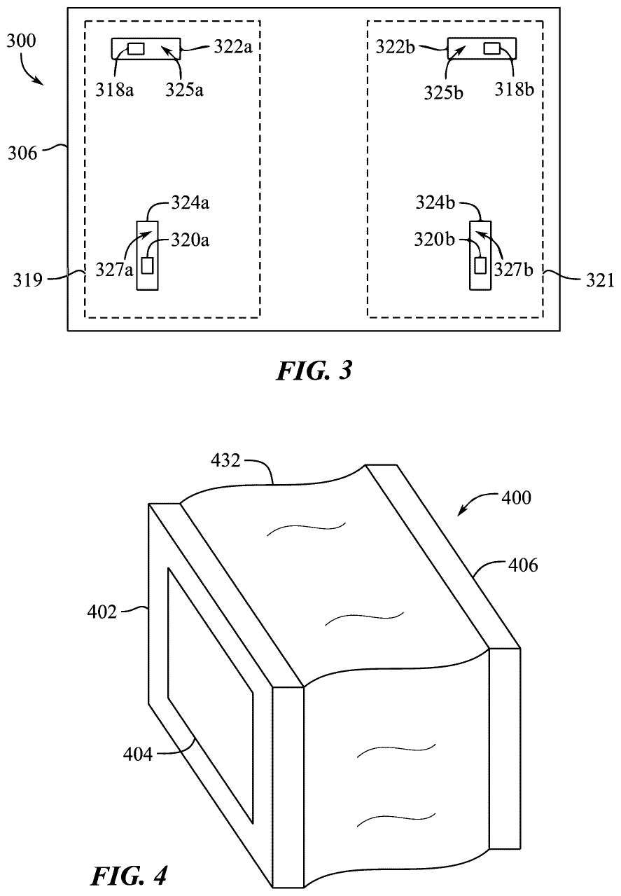

FIG. 3 illustrates a front view of the facial track 306 with sliding joints, in accordance with one or more examples of the present disclosure. In some examples, the head-mountable device 300 can include sliding joints. In the example illustrated in FIG. 3, sliding joints can be disposed within the facial track 306. In other examples of the present disclosure, sliding joints can be disposed within the display frame (e.g., the display frame 102 in FIG. 1).

In at least one example, the head-mountable device 300 can include a first set of sliding joints 319 and a second set of sliding joints 321. In one or more examples, the first set of sliding joints 319 can be configured to receive the first set of extension arms (e.g., first set of extension arms 125 in FIG. 1). More specifically, the first set of sliding joints 319 can include a first sliding joint 322a and a second sliding joint 324a. In some examples, the first sliding joint 322a can be configured to receive the second end 318a of the first extension arm (e.g., first extension arm 108 in FIG. 1). Similarly, the second sliding joint 324a can be configured to receive the second end 320a of the second extension arm (e.g., second extension arm 110 in FIG. 1).

In some examples, the second ends 318a and 320a of the first and second extension arms 108 and 110 can be a combination of indents and detents. In one example, the second ends 318a and 320a of the first and second extension arms 108 and 110 can be spherical detents. In this example, the first set of sliding joints 319 can be spherical indents disposed within the facial track 306 or the display frame 102. Additionally, the first and second sliding joints 322a and 324a can be bigger than the second ends 318a and 320b of the first set of extension arms 125. This can enable the second ends 318a and 320a to move around the first sliding joint 322a and the second sliding joint 324a. In some examples of the present disclosure, joints other than spherical joints can be used to connect the sliding joints 322a and 324a to the second ends 318a and 320a of the first set of extension arms 125.

In some examples, the first sliding joint 322a of the first set of sliding joints 319 can include a first channel 325a extending in a first direction. As shown in FIG. 3, the first sliding joint 322a can be configured in a horizontal direction, as oriented with the facial track 306. In some examples, the direction of the first channel 325a can extend in various directions other than a horizontal direction. In some examples, the second sliding joint 324a can include a second channel 327a extending in a second direction different from the direction of the first channel 325a. For example, the second channel 327a can extend in a vertical direction, as oriented with the facial track 306 shown in FIG. 3. Other directions of the first and second channels 325a and 327a can extend in diagonal directions of varying degrees.

In some examples, the first and second channels 325a and 327a can be larger than the second ends 318a and 320a of the first and second extension arms 108 and 110. In at least one example, the first and second channels 325a and 327a can extend in different directions, where the first and second channels 325a and 327a are longer in the extended direction. As shown in FIG. 3, the first and second channels 325a and 327a can conform to the shape of the second ends 318a and 320a in one direction, but extend in another direction longer than the size of the second ends 318a and 320a. In this way, the first channel 325a and the second channel 327a can limit movement of the second ends 318a and 320a within the direction of the channels of the first and second sliding joints 322a and 324a.

In some examples, the second end 318a of the first extension arm 108 can travel across the first channel 325a. Similarly, the second end 320a of the second extension arm 110 can travel across the second channel 327a. In some examples, the second ends 318a and 320a can travel across the first sliding joint 322a and the second sliding joint 324a during linear adjustment of the head-mountable device 300.

In some examples, a first movement of the second end 318a of the first extension arm 108 in the first sliding joint 322a and a second movement of the second end 320a of the second extension arm 110 in the second sliding joint 324a can cause guided linear motion between the facial track 306 and the display frame 102. Additionally, the second ends 318a and 320a travelling across the first and second sliding joints 322a and 324a can reduce off-axis moments of the facial track 306 in relation to the display frame 102. The sliding joints can further enable the facial track 306 to remain in-axis to the display frame 102 at various stages of linear adjustment. For example, at different distances between the facial track 306 and the display frame 102, the second ends 318a and 320a can move in the first and second channels 325a and 327a to center different components of the head-mountable device 300. This can enhance the comfort of the user by keeping various components of the head-mountable device 300 centered during operation and/or adjustment.

In some examples, the second set of sliding joints 321 can be similar in structure and functionality to the first set of sliding joints 319. In at least one example, the second set of sliding joints 321 can include sliding joints 322b and 324b. In some examples, the sliding joints 322b and 324b can be configured to receive second ends 318b and 320b of the second set of extension arms 126.

In one or more examples of the present disclosure, the second set of sliding joints 321 and the second ends 318b and 320b can operate similar to the functionalities described above. For example, the sliding joints 322b and 324b can be configured to receive the second ends 318b and 320b. The sliding joints 322b and 324b can further include additional channels 325b and 327b extending in different directions from each other. Additionally, the directions of the sliding joints 322b and 324b can be mirrored from the first set of sliding joints 319. Furthermore, the second ends 318b and 320b can be configured to travel across the channels 325b and 327b of the second set of sliding joints 321. The second set of sliding joints 321 can increase the stability of the head-mountable device 300. Movement of the second ends 318b and 320b in the first and second sliding joints 322b and 324b of the second set of sliding joints 321 can further enable guided linear motion between the facial track 306 and the display frame 102.

Any of the features, components, and/or parts, of the rim 360 including the arrangements and configurations thereof shown in FIGS. 3A and 3B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 3A and 3B.

FIG. 4 illustrates a perspective view of the head-mountable device 400, in accordance with one or more examples of the present disclosure. In some examples, the head-mountable device 400 can include a light-blocking shroud 432. In some examples, the light-blocking shroud 432 can be a flexible material, such as a textile, rubber, or soft plastic. In some examples, the light-blocking shroud 432 can be constructed out of more rigid materials.

In some examples, the light-blocking shroud 432 can be disposed between the display frame 402 and the facial track 406. In one or more examples, the light-blocking shroud 432 can be coupled to the display frame 402 and the facial track 406. In some examples, the light-blocking shroud 432 can enclose the first extension arm (e.g., first extension arm 108 in FIG. 1) and the second extension arm (e.g., second extension arm 110 in FIG. 1). In some examples, the light-blocking shroud 432 can enable the user of the head-mountable device 400 to view the optical component 404 when donning the head-mountable device 400 with a reduction in light interference. This can help the user more easily operate the head-mountable device 400 and view the data projected by the head-mountable device via the optical component 404.

Any of the features, components, and/or parts, of the arrangements and configurations thereof shown in FIG. 4 can be included, cither alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 4.

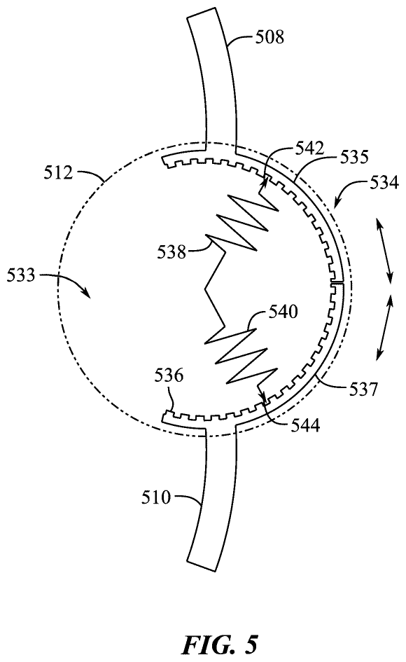

FIG. 5 illustrates a side-view of the rotational hinge 512, in accordance with one or more examples of the present disclosure. In some examples, the rotational hinge 512 can include a spring-detent locking mechanism 533. In some examples, the spring-detent locking mechanism 533 can be configured to lock the first extension arm 508 in any one of a set of discrete positions. In some examples, the set of discrete positions can be correlated to a change in the distance between the facial track (e.g., facial track 106 in FIG. 1) and the display frame (e.g., display frame 102).

In some examples, the spring-detent locking mechanism 533 can include a detent ring 534. In some examples, the detent ring 534 can be rounded in shape, with a series of detents 536 defined by or otherwise lining the inside of the detent ring 534. In some examples, the detent ring 534 can further include at least two separate sections. In some examples, the two separate sections of the detent ring 534 can be connected to the first extension arm 508 and the second extension arm 510, respectively. In some examples, a first ring section 535 can be coupled or correspond to the first extension arm 508. Similarly, a second ring section 537 can be coupled or correspond to the second extension arm 510.

In some examples, the first ring section 535 and the second ring section 537 can rotate with the actuation of the rotational hinge 512. As shown in FIG. 5, the first ring section 535 can rotate in a direction different than the direction of the second ring section 537. For example, when increasing or decreasing the distance between the facial track 106 and the display frame 102, the first and second extension arms 508 and 510 can move closer together or farther away from one another. Within the rotational hinge 512, the first ring section 535 and the second ring section 537 can move in different directions correlated with the movements of the first and second extension arms 508 and 510. In some examples, the first ring section 535 and the second ring section 537 can overlap. This can enable a wide range of motion for the first and second extension arms 508 and 510, which can directly correlate to a wider range of distance possible between the display frame 102 and the facial track 106.

In some examples, the rotational hinge 512 can further include a first locking spring 538 and a second locking spring 540. In some examples, the first and second locking springs 538 and 540 can be disposed within the rotational hinge 512 and can be configured to help lock the first and second securement arms 508 and 510 in different positions. In at least one example, the first extension arm 508 and the second extension arm 510 can lock in various positions during a linear adjustment of the facial track 106 relative to the display frame 102.

In some examples, the first locking spring 538 can further include a first locking stop 542. In one or more examples, the first locking stop 542 can be disposed on an end of the first locking spring 538. In at least one example, the first locking stop 542 can rest between two detents 536 on the first ring section 535. In some examples, spring retention can enable the first locking spring 538 to push the first locking stop 542 between two detents 536 on the first ring section 535. This spring retention can help lock the first extension arm 508 in a position desired by the user of the head-mountable device (e.g., the head-mountable device 100 in FIG. 1). When the first extension arm 508 is rotated via actuation of the rotational hinge 512, the first locking spring 538 can compress, enabling the first locking stop 542 to move between different detents 536 on the first ring section 535. In some examples, this can help lock the first extension arm 508 in a new position.

Similarly, the second locking spring 540 can further include a second locking stop 544. In one or more examples, the second locking stop 544 can be disposed on an end of the first locking spring 538. In at least one example, the first locking stop 542 can rest between two detents 536 on the second ring section 537. In some examples, spring retention can enable the second locking spring 540 to push the second locking stop 544 between two detents 536 on the second ring section 537. This spring retention can help lock the second extension arm 510 in a position desired by the user of the head-mountable device 100. When the second extension arm 510 is rotated via actuation of the rotational hinge 512, the second locking spring 540 can compress, enabling the second locking stop 544 to move between different detents 536 on the second ring section 537. In some examples, this can help lock the second extension arm 510 in a new position.

Any of the features, components, and/or parts, of the rim 360 including the arrangements and configurations thereof shown in FIGS. 5A and 5B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 5A and 5B.

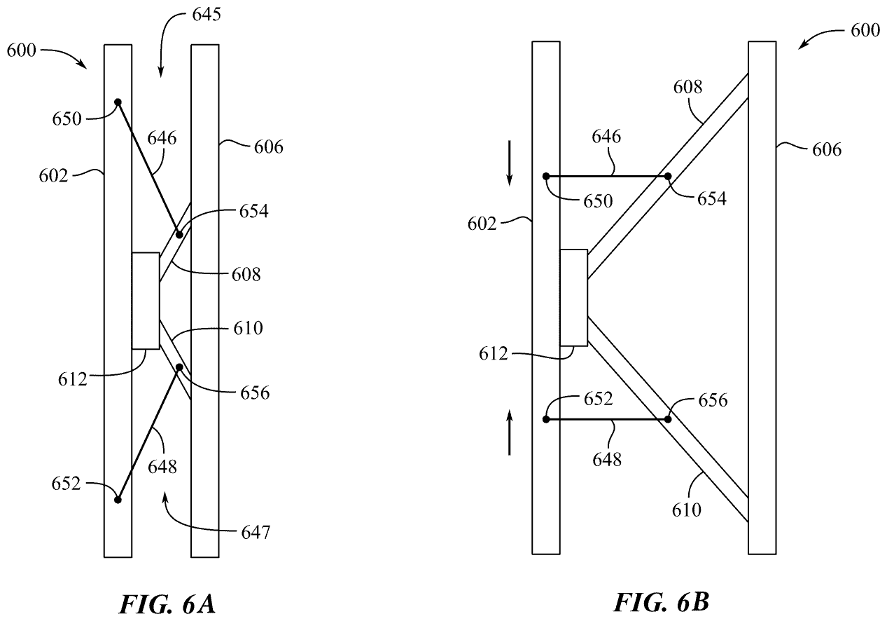

FIG. 6A illustrates a side view of the head-mountable device 600, in accordance with one or more examples of the present disclosure. In some examples, the head-mountable device 600 can include a sliding lock 645. In some examples, the sliding lock 645 can be configured to lock the rotational hinge 612 in place. In at least one example, the sliding lock 645 can include a locking arm 646. In some examples, the locking arm 646 can be a strut, rod, or other elongated member coupled to the head-mountable device 600. In one or more examples, the locking arm 646 can be constructed out of a rigid material. In some examples, the locking arm can be made out of metal, polymer, carbon fiber, or other rigid material.

In some examples, the locking arm 646 can be coupled to the head-mountable device 600 via a sliding point 650. In some examples, the sliding point 650 can be a portion of the head-mountable device 600 configured to slide across the surface of the head-mountable device 600. As shown in FIG. 6, the sliding point 650 can be disposed on the display frame 602. In other examples, the sliding point 650 can be disposed on the facial track 606. In further examples of the present disclosure, the sliding point 650 can be disposed on the component that is coupled to the rotational hinge 612.

In some examples, the locking arm 646 can extend from the sliding point 650 and couple to the first extension arm 608. In some examples, the locking arm 646 can couple to the first extension arm 608 via a locking point 654. In one or more examples, the locking point 654 is configured to be secured in a fixed position on the first extension arm 608. In at least one example, the locking arm 646 can be configured to lock the first extension arm 608 in position. This can reduce movement of the first extension arm 608 and further reduce movement between the facial track 606 and the display frame 602. In some examples, the locking arm 646 can lock the position of the display frame 602 relative to the facial track 606.

In some examples, the sliding point 650 can be disposed on the second extension arm 610. In this example, the locking arm 646 can extend from the display frame 602 or the facial track 606 and secured to the second extension arm 610. In this example, the locking arm 646 can be configured to lock the second extension arm 610 in position. This can also lock the position of the display frame 602 relative to the facial track 606.

In some examples, the head-mountable device 600 can include one or more additional sliding locks. As shown in FIG. 6A, the head-mountable device 600 can include at least a second sliding lock 647. In some examples, the second sliding lock 647 can lock the rotational hinge 612 in place. Similar to the sliding lock 645, the second sliding lock 647 can include a second locking arm 648. In at least one example, the second locking arm 648 can couple to either the display frame 602 or the facial track 606 via a second sliding point 652, where the second sliding point 652 is configured to slide across the surface of the head-mountable device 600.

In some examples, the second locking arm 648 can extend from either the display frame 602 or the facial track 606 to a second locking point 656 disposed on an extension arm. As shown in FIG. 6A, the second locking point 656 can be disposed on the second extension arm 610. In this example, the second locking arm 648 can be configured to lock the second extension arm 610 in place.

In some examples, the second locking point 656 can be disposed at the first extension arm 608, or an extension arm on the second set of extension arms (e.g., the second set of extension arms 126 in FIG. 1). In this example, locking arms can be disposed on both the first set of extension arms (e.g., the first set of extension arms 125 in FIG. 1) and the second set of extension arms 126. This can enable the display frame 602 to be securely locked in position relative to the facial track 606.

FIG. 6B illustrates a side view of another position of the head-mountable device 600 where the sliding point 650 has moved, in accordance with one or more examples of the present disclosure. In some examples, the sliding point 650 can be moved across the surface of the head-mountable device 600. As shown in FIG. 6B, as the sliding point 650 is moved across the display frame 602, the locking arm 646 can also move. FIG. 6B shows movement of the sliding point 650 to increase the distance between the display frame 602 and the facial track 606. With similar movements of the sliding point 650, the locking arm 646 can be configured to extend or retract. In some examples, movement of the sliding point 650 can cause the locking arm 646 to move the first extension arm 608, thereby changing the distance between the facial track 606 and the display frame 602.

In some examples, the second sliding point 652 can also be moved across the surface of the head-mountable device 600. As shown in FIG. 6B, as the second sliding point 652 is moved across the display frame 602, the second locking arm 648 can also move. With this motion, the second locking arm 648 can extend or retract. In some examples, movement of the sliding point 650 can cause the second locking arm 648 to move an extension arm from either the first set of extension arms 126 or the second set of extension arms 125, thereby changing the distance between the facial track 606 and the display frame 602. In some examples, the second sliding point 652 can be configured to move in correlation with the sliding point 650. This can further increase the rigidity and stability of the head-mountable device 600 when changing the distance between the facial track 606 and the display frame 602.

In some examples, the sliding point 650 (or the second sliding point 652) can be configured to lock in place in various positions while being moved across the head-mountable device 600. This can enable the locking arm 646 to secure the display frame 602 relative to the facial track 606 at various distances as the sliding point 650 is moved.

In some examples, movement of the sliding point 650 and the second sliding point 652 can be manually actuated by the user of the head-mountable device 600. For example, the user can push the sliding point 650 across the surface of the head-mountable device 600 to change the extension of the locking arm 646. In other examples, the movement of the sliding point 650 or the second sliding point 652 can be actuated by a motor. In some examples, the first sliding lock 645 and/or the second sliding lock 547 can enable the user of the head-mountable device 600 to easily change the distance between the facial track 606 and the display frame 602.

Any of the features, components, and/or parts, of the arrangements and configurations thereof shown in FIGS. 6A and 6B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 6A and 6B.

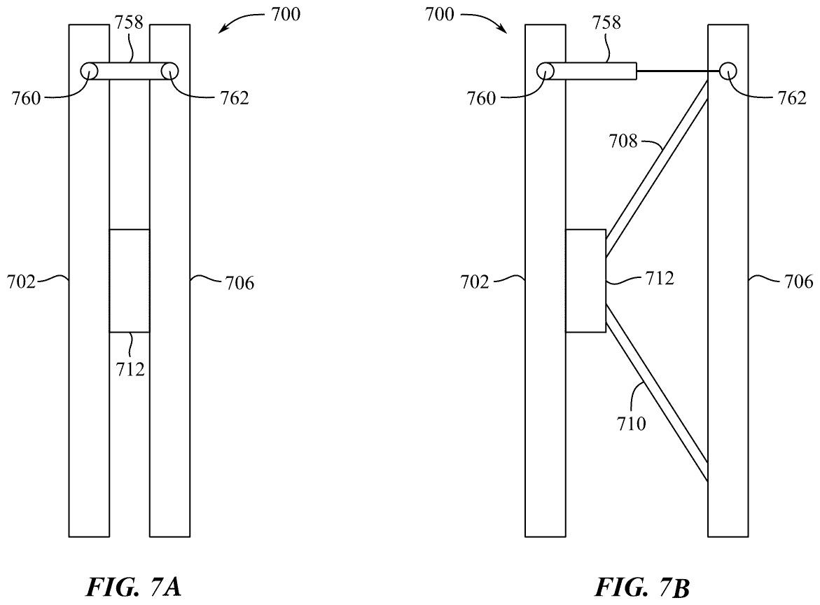

FIG. 7A illustrates a side view of the head-mountable device 700, in accordance with one or more examples of the present disclosure. In some examples, the head-mountable device 700 can include an expandable link 758. In some examples, the expandable link 758 can be a rigid elongated member that can couple the display frame 702 to the facial track 706. In some examples, the expandable link 758 can be configured to extend or retract. For example, the expandable link 758 can be a telescoping rod that can change length. FIG. 7A shows an example of the expandable link 758 in a fully retracted position. In this position, the distance between the display frame 702 and the facial track 706 can be relatively small.

In some examples, the expandable link 758 can be coupled to the display frame 702 via a display securement 760. Similarly, and in some examples, the expandable link 758 can be coupled to the facial track 706 via a track securement 762. In at least one example, the display securement 760 and the track securement 762 can be disposed in line with each other, such that the expandable link 758 can extend straight from the display frame 702 to the facial track 706 or vice versa.

In some examples, the expandable link 758 can be configured to lock its length. In at least one example, the locking of the expandable link 758 can further lock the rotational hinge 712 in place. This can enable the expandable link 758 to lock the position of the display frame 702 relative to the facial track 706. Furthermore, and in some examples, the expandable link 758 is configured to change the size of the gap between the facial track 706 and the display frame 702.

FIG. 7B illustrates a side view of another position of the head-mountable device 700 where the expandable link 758 is extended, in accordance with one or more examples of the present disclosure. In some examples, the expandable link 758 can extend, increasing the distance between the facial track 706 and the display frame 702. In some examples, the expandable link 758 can lock at different lengths of extension, thus securing the display frame 702 at various distances relative to the facial track 706.

In some examples, the extension of the expandable link 758 can cause the movement of at least the first extension arm 708 and the second extension arm 710. In at least one example, the expandable link 758 can cause the first extension arm 708 and the second extension arm 710 to extend or retract. In some examples, the locking of the expandable link 758 can cause the actuation of the rotational hinge 712, which can further increase the stability of locking the display frame 702 relative to the facial track 706.

In some examples, the expansion and/or retraction of the expandable link 758 can be manually actuated by the user of the head-mountable device 700. For example, the user can push/pull the head-mountable device 700 to change the length of the expandable link 758. In other examples, the expansion and/or retraction of the expandable link 758 can be actuated by a motor. In some examples, the expansion and/or retraction of the expandable link 758 can enable the user of the head-mountable device 700 to easily change the distance between the facial track 706 and the display frame 702.

Any of the features, components, and/or parts, of the arrangements and configurations thereof shown in FIGS. 7A and 7B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 7A and 7B.

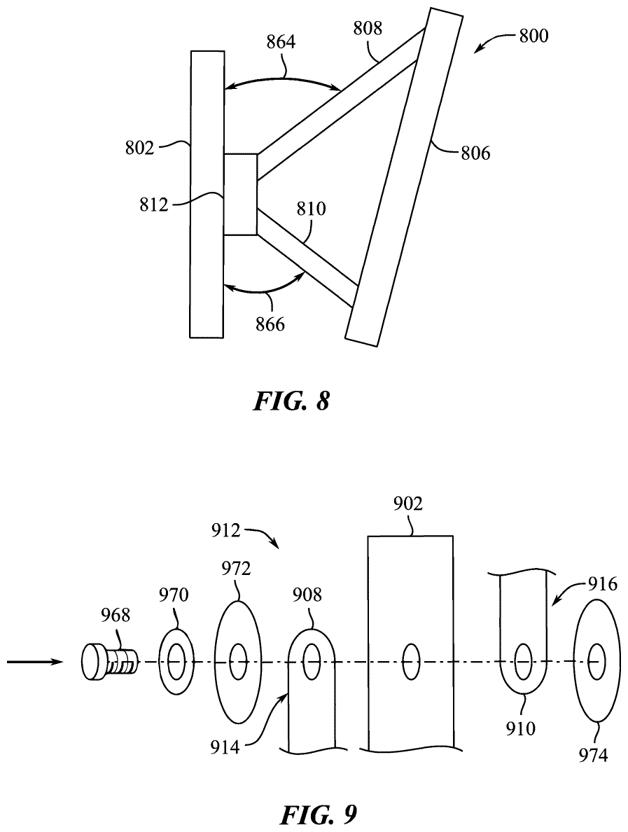

FIG. 8 illustrates a side view of the head-mountable device 800, in accordance with one or more examples of the present disclosure. In some examples, the angle of the display frame 802 relative to the facial track 806 can be changed. For example, FIG. 8 shows the display frame 802 facing at a canted angle relative to the facial track 806.

In at least one example, the first extension arm 808 can be extended differently than the second extension arm 810. In some examples, the difference of extension between the first extension arm 808 and the second extension arm 810 can change the angle of the display frame 802 relative to the facial track 806. For example, and as shown in FIG. 8, the extension of the first extension arm 808 can be defined by a first arm angle 864. In at least one example, the first arm angle can be the angle between the first extension arm 808 and the display frame 802 or the facial track 806 (whichever component is directly coupled to the rotational hinge 812). Similarly, the extension of the second extension arm 810 can be defined by a second arm angle 866. In some examples, the second arm angle 866 can be defined by the angle between the second extension arm 810 and the display frame 802 or facial track 806.

In some examples, when the first arm angle 864 is a different size compared to the second arm angle 866, the display frame 802 can be canted at an angle relative to the facial track 806. This can enable the user of the head-mountable device 800 to cant the display frame at a desired and/or comfortable position.

Any of the features, components, and/or parts, of the arrangements and configurations thereof shown in FIG. 8 can be included, cither alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 8.

FIG. 9 illustrates a blown-up perspective view of the rotational hinge 912, in accordance with one or more examples of the present disclosure. In some examples, the rotational hinge 912 can include a friction clutch. In at least one example, the friction clutch can be configured to be fixed in position when not acted upon by an external force. This can enable the rotational hinge 912 to move when desired by the user of the head-mountable device (e.g., the head-mountable device 10 in FIG. 1). Additionally, the rotational hinge 912 can be removably secured to the head-mountable device 100. In some examples, the rotational hinge 912 can be secured to the head-mountable device 100 via the clutch fastener 968.

In some examples, the friction clutch of the rotational hinge 912 can include a clutch fastener 968. In some examples, the clutch fastener 968 can be a screw, rod, or other elongated insert. In some examples, the clutch fastener 968 can be configured to fasten various components of the rotational hinge to the head-mountable device 100. FIG. 9 shows the clutch fastener 968 securing components to the display frame 902. In some examples of the present disclosure, the clutch fastener 968 can also be configured to secure components to the facial track (e.g., the facial track 106 in FIG. 1). In some examples, the clutch fastener 968 can extend through various components of the friction clutch, securing them to the head-mountable device 100.

In at least one example, the clutch fastener 968 can extend through a washer 970. In some examples, the washer 970 can provide a buffer between the components of the rotational hinge 912 and the clutch fastener 968. In some examples, the clutch fastener 968 can also extend through a first constrained washer 972. In some examples, the first constrained washer 972 can be rotationally constrained to the head-mountable device 100. In FIG. 9, the first constrained washer 972 can be constrained to the shape of the display frame 902.

In at least one example, the clutch fastener 968 can also extend through the first end 914 of the first extension arm 908. In some examples, the clutch fastener 968 can extend through the display frame 902 (or facial track 106), and through the first end 916 of the second extension arm 910. In some examples, the clutch fastener 968 can further extend through a second constrained washer 974. In one or more examples of the present disclosure, the second constrained washer 974 can be rotationally constrained to the head-mountable device 100. In FIG. 9, the second constrained washer 974 can be constrained to the shape of the display frame 902.

In some examples, the friction clutch can include the clutch fastener 968, washer 970, first constrained washer 972, and second constrained washer 974. In at least one example, these components can be tightened such that the first extension arm 908 and the second extension arm 910 will not move without an external force. In some examples, the first constrained washer 972 and the second constrained washer 974 cannot rotate with the actuation of the friction clutch, thereby increasing the friction on the first and second extension arms 908 and 910.

Any of the features, components, and/or parts, of the arrangements and configurations thereof shown in FIG. 9 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 9.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. A head-mountable device, comprising:
a display frame;
an optical component coupled to the display frame;
a facial track; and
an adjustment assembly, comprising:
a rotational hinge;
a first sliding joint;
a second sliding joint;
a first extension arm coupling the display frame and the facial track; and
a second extension arm coupling the display frame and the facial track;
wherein:
a first end of the first extension arm and a first end of the second extension arm are connected to the rotational hinge;
a second end of the first extension arm is connected to the first sliding joint;
a second end of the second extension arm is connected to the second sliding joint; and
the adjustment assembly is configured to cause a linear adjustment of the display frame relative to the facial track.

2. The head-mountable device of claim 1, further comprising:
a first set of extension arms including the first extension arm and the second extension arm; and
a second set of extension arms disposed opposite the first set of extension arms, the second set of extension arms including a third extension arm and a fourth extension arm.

3. The head-mountable device of claim 1, wherein:
the rotational hinge is a first rotational hinge; and
the head-mountable device comprises a second rotational hinge.

4. The head-mountable device of claim 1, wherein the linear adjustment of the facial track and the display frame correspond to at least one of a change in a depth of field or a change in a field of view as perceived by a user of the head-mountable device.

5. The head-mountable device of claim 1, wherein the rotational hinge is configured to lock in different positions corresponding to the linear adjustment of the facial track and the display frame.

6. The head-mountable device of claim 1, wherein the linear adjustment is guided by the first set of extension arms and the second set of extension arms.

7. The head-mountable device of claim 1, wherein:
the first extension arm is curved; and
the second extension arm is curved.

8. The head-mountable device of claim 1, further comprising a light-blocking shroud surrounding the first extension arm and the second extension arm, the light-blocking shroud disposed between the facial track and the display frame.

9. A wearable apparatus, comprising:
a head-mountable display;
a facial contact;
a rotational hinge;
a first support link adjustably securing the head-mountable display to the facial contact; and
a second support link adjustably securing the head-mountable display to the facial contact;
wherein:
the first support link and the second support link define a gap between the facial contact and the head-mountable display;
a first end of the first support link and a first end of the second support link are connected to the rotational hinge;
an actuation of the rotational hinge is configured to change a size of the gap between the facial contact and the head-mountable display; and
the rotational hinge is configured to lock the first support link in a position defining a size of the gap.

10. The wearable apparatus of claim 9, wherein the rotational hinge is configured to be manually actuated.

11. The wearable apparatus of claim 9, wherein the rotational hinge is configured to be actuated by a motor.

12. The wearable apparatus of claim 9, wherein the rotational hinge comprises a spring-detent locking mechanism configured to lock the first support link in any one of a set of discrete positions including the position.

13. The wearable apparatus of claim 9, wherein the rotational hinge includes a friction clutch, the friction clutch configured to be fixed when not acted upon by an external force.

14. The wearable apparatus of claim 9, wherein the rotational hinge is removably secured to the wearable apparatus.

15. The wearable apparatus of claim 9, wherein an expandable link is disposed between the head-mountable display and the facial contact, the expandable link configured to change the gap between the facial contact and the head-mountable display.

16. The wearable apparatus of claim 9, further comprising a sliding lock configured to lock the rotational hinge in place, the sliding lock comprising a locking arm connected between the wearable apparatus and at least one of the first support link or the second support link.

17. A display adjustment assembly, comprising:
a display frame;
an optical component coupled to the display frame;
a facial track;
a first extension arm disposed between the display frame and the facial track;
a second extension arm disposed between the display frame and the facial track, wherein the first extension arm and the second extension arm define a gap between the facial track and the display frame;
a first end of the first extension arm and a first end of the second extension arm are both rotationally secured to the display frame or the facial track;
a first sliding joint configured to receive a second end of the first extension arm; and
a second sliding joint configured to receive a second end of the second extension arm.

18. The display adjustment assembly of claim 17, wherein:
the first sliding joint comprises a channel extending in a first direction; and
the second end of the first extension arm is configured to travel across a length of the channel.

19. The display adjustment assembly of claim 17, wherein:
the second sliding joint comprises a channel extending in a second direction different than the first direction; and
the second end of the second extension arm is configured to travel across a length of the channel.

20. The display adjustment assembly of claim 17, wherein a first movement of the first extension arm in the first sliding joint and a second movement of the second extension arm in the second sliding joint cause guided linear motion between the facial track and the display frame.
